(19) United States
(12) Patent Application Publication
(10) Pub. No.: US 2003/0214610 A1
(43) Pub. Date: Nov. 20, 2003

(54) Sensor signal processing for automatic convergence

(76) Inventor: John Barrett George, Carmel, IN (US)

Correspondence Address: JOSEPH S. TRIPOLI, THOMSON LICENSING INC., 2 INDEPENDENCE WAY, Suite 200, P.O. BOX 5312, PRINCETON, NJ, 08543-5312, US

(21) Appl. No.: 10/465,091

(22) Filed: Jun. 19, 2003

Related U.S. Application Data
(63) Continuation of application No. 09/657,646, filed on Sep. 7, 2000.

(51) Int. Cl. H04N 9/28

(52) U.S. Cl. 348/745; 348/807

(57) ABSTRACT

A projection display device includes a screen image measuring arrangement and is subject to unwanted illumination. The measuring arrangement comprises a photo sensor located adjacent to an edge of the screen for generating an output signal having a first component responsive to illumination by a projected image and a second component responsive to illumination by the unwanted illumination. A filter is coupled to the photo sensor for filtering the output signal to pass the first component of the output signal and to attenuate an amplitude of the second component of the output signal.

### FIELD OF THE INVENTION

This invention relates to the field of video projection display and in particular to the detection of projected images and the processing of photo generated signals occurring in the presence of ambient illumination.

### BACKGROUND OF THE INVENTION

In a projection video display, geometric raster distortions result from the physical placement of the cathode ray display tubes. Such raster distortions are exacerbated by the use of cathode ray tubes with curved, concave phosphor surfaces and the inherent magnification in the optical projection path. The projected image is composed of three scanning rasters which are required to be in register one with the other on a viewing screen. The precise overlay of the three projected images requires the adjustment of multiple waveforms to compensate for geometrical distortion and facilitate the superimposition of the three projected images. However, manual alignment of multiple waveforms is labor intensive during manufacturing, and without the use of sophisticated test equipment may preclude setup at a user location. An automated convergence system which simplifies manufacturing alignment and facilitates user location adjustment may employ raster edge measurement at peripheral display screen locations in order to determine raster size and convergence. However, such automatic convergence systems can encounter problems when functioning with moderate levels of ambient light incident on the display screen. Typically a malfunction results when, in an attempt to reduce the effect of the unwanted illumination, the automatic setup system reduces the detector sensitivity to a level where the green channel marker or calibration signal, the most difficult color to detect, can not be detected. At such a juncture an on screen message is generated and displayed advising that the ambient light intensity is too great and the auto-alignment action is terminated. Such setup failures are problematic where automatic converge is to be performed under less than ideal conditions, for example when lit with spot lights or in large display areas with uncontrollable illumination.

The unwanted ambient illumination can be the product of sunlight, and or incandescent or fluorescent light sources. Sunlight or daylight is most likely subject to random variation of intensity due to the passage of clouds together with the formation of shadows cast across the display surface. These random variations of intensity cause a large amplitude, low frequency variation of the sensor signal. Artificial illumination will, in addition to intensity variation due to shadows, generate in the sensor signal a noise frequency spectra related to the power line frequency. Hence it can be appreciated a photo sensor signal can comprise a mixture of wanted and unwanted signal components where the wanted projected image component is subject to a severely impaired signal to noise ratio.

### SUMMARY OF THE INVENTION

A projection display device includes a screen image measuring arrangement and is subject to unwanted illumination. The measuring arrangement comprises a photo sensor located adjacent to an edge of the screen for generating an output signal having a first component responsive to illumination by a projected image and a second component responsive to illumination by the unwanted illumination. A filter is coupled to the photo sensor for filtering the output signal to pass the first component of the output signal and to attenuate an amplitude of the second component of the output signal.

In a further inventive embodiment, an automatic convergence arrangement for a projection display apparatus comprises a digital convergence circuit generating a convergence image for projection. The digital convergence circuit determines convergence error correction responsive to measurement of the projected convergence image. A photo sensor is located adjacent to a display surface for the projected convergence image and generates a sensor signal responsive to illumination by the projected convergence image and ambient light. A filter for the sensor signal has a characteristic which enhances frequency components of the sensor signal being indicative of the projected convergence image and attenuates frequency components of the sensor signal being indicative the ambient light. The sensor signal, processed by the filter, is coupled to the digital convergence circuit for measurement.

### BRIEF DESCRIPTION OF THE DRAWINGS

FIG. 1 is a simplified front view of a projection video display.

FIG. 2 is a simplified block diagram of a video image projection display apparatus including inventive features.

FIG. 3A is a schematic diagram showing a digitally controlled current source, sensor signal detector and an inventive sensor signal processor.

FIG. 3B is a schematic diagram showing a further inventive sensor signal processor.

FIGS. 4A, 4B 4C 4D and 4E are simulations depicting sensor signal processing in the presence of ambient light interference.

FIG. 5 is a simulation depicting the amplitude versus frequency response of inventive processors 280 and 280A with an input current of 50 microamperes.

FIG. 6 is a simulation depicting the amplitude versus frequency response of the inventive processors 280 and 280A with an input interference signal of 1 volt amplitude.

### DETAILED DESCRIPTION

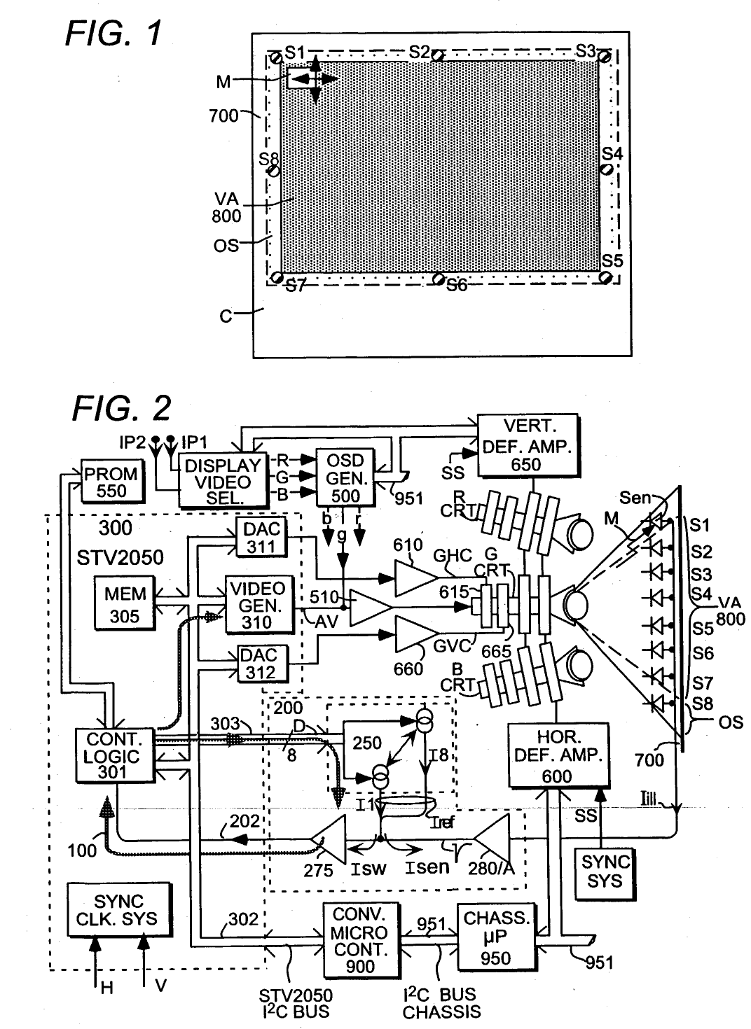

FIG. 1 illustrates a front view of a video projection display apparatus. The projection display comprises a plurality of cathode ray tubes with raster scanned images which are projected on to screen 700. A cabinet supports and surrounds screen 700 and provides a picture display area 800 which is slightly smaller than the screen. Screen 700 is depicted with a broken line to indicate an edge area which is concealed within cabinet C and which may be illuminated with raster scanned images when operated in an overscan mode as indicated by area OS. Photo sensors are located adjacent to the periphery of screen 700 within the concealed edge area and outside viewed area 800. However, raster scanned images can also be projected to produce a picture display on a screen or surface which is not suspended within or partially concealed by a cabinet. This method of picture display is known as a front projection display. In a front projection arrangement photo sensors are located as described previously, but in an unconcealed position adjacent to the periphery of screen. Operation of an automatic convergence correction system which will be described is equally applicable to front or back display projection. Eight sensors are shown in FIG. 1, positioned at the corners and at the centers of the screen edges. With these sensor positions it is possible to measure an electronically generated test pattern, for example peak video value block M, to determine picture width and height and certain geometric errors, for example, rotation, bow, trapezium, pincushion etc., and thereby align the displayed images to be superimposed one with the other over the whole of the screen area. Measurements are performed in both horizontal and vertical directions in each of the three projected color images thus yielding at least forty eight measured values.

Operation of the measurement and alignment system will be explained with reference to FIG. 2 which depicts in block diagram form, part of a raster scanned video projection display. In FIG. 2 three cathode ray tubes, R, G and B form raster scanned monochromatic color images which are directed through individual lens systems to converge and form a single display image 800 on screen 700. Each cathode ray tube is depicted with four coil sets which provide horizontal and vertical deflection and horizontal and vertical convergence. The horizontal deflection coil sets are driven by a horizontal deflection amplifier 600 and vertical deflection coil sets are driven by a vertical deflection amplifier 650. Both horizontal and vertical deflection amplifiers are driven with deflection waveform signals that are controlled in amplitude and waveshape via data bus 951 and synchronized with the signal source selected for display. Exemplary green channel horizontal and vertical convergence coils 615 and 665 respectively, are driven by amplifiers 610 and 660 respectively, which are supplied with convergence correction waveform signals. The correction waveform signals GHC and GVC may be considered representative of DC and AC convergence signals, for example static and dynamic convergence. However, these functional attributes may be facilitated, for example by modifying all measurement location addresses by the same value or offset to move the complete raster and achieve an apparent static convergence or centering effect. Similarly, a dynamic convergence effect may be produced by modification of the location address of a specific measurement location. Correction waveform signals GHC and GVC for the green channel are generated by exemplary digital to analog converters 311 and 312 which convert digital values read from memory 550.

An input display signal selector selects, by means of bus 951, between two signal sources IP1 and IP2, for example a broadcast video signal and an SVGA computer generated display signal. Video display signals RGB, are derived from the display video selector and electronically generated message information, for example user control information, display setup and alignment signals and messages generated responsive to commands from controllers 301, 900 and 950 coupled via buses 302 and 951, may be combined by on screen display generator 500. During automated sensitivity calibration or convergence alignment, controller 900 sends commands via a data bus 302 to controller 301 which instructs video generator 310 to generate an exemplary green channel calibration video test signal AV comprising an exemplary black level signal with a rectangular block M having a predetermined video amplitude value. Controllers 900 and 301 also position block M to illuminate exemplary sensor S1 by determining horizontal and vertical timing to position block M within the scanned display raster or by moving the scanned raster, or a part of the scanned raster containing the marker block M. Green channel test signal AV is output from IC 300 and combined at amplifier 510, with the green channel output signal from on screen display generator 500. Thus, the output signal from amplifier 510 is coupled to exemplary green cathode ray tube GCRT, and may include display source video and or OSD generated signals and or IC 300 generated calibration video test signals AV.

Controller 301 also executes a program stored in program memory 308 which comprises various algorithms. To facilitate an initial setup adjustment controller 301 outputs a digital word D on data bus 303, which is coupled to a controllable current source 250. The digital word D represents a sensor specific current to be generated by current source 250 and supplied to sensor detector 275.

To facilitate adjustment and alignment of the three color images, setup block M is generated as described previously and coupled to exemplary green CRT. In FIG. 1 test pattern block M is shown approaching sensor S1, and as previously mentioned each sensor may be illuminated by the timed generation of the marker block within a video signal projected with an overscanned raster, or by positioning the scanned raster such that marker block M lights sensor S1. With certain display signal inputs, for example computer display format signals, substantially all of the scanned area may be utilized for signal display thus operation with an overscanned raster is largely precluded. During operation with computer display format signals, raster overscan is limited to a nominal few percent, for example 1%. Hence under these substantially zero overscan conditions exemplary sensor S1 may be illuminated by raster positioning of block M. Clearly, individual sensor illumination may be facilitated with a combination of both video signal timing and raster positioning or temporary raster enlargement.

Each sensor generates an electron flow which enables conduction in a substantially linear relationship to the intensity of the illumination incident thereon. However, the intensity of illumination at each individual sensor may vary greatly for a number of reasons, for example, the phosphor brightness of each individual CRT may be different, there may be lens and optical path differences between the three monochromatic color images. As each CRT ages the phosphor brightness declines, furthermore with the passage of time, dust may accumulate within the optical projection path to reduce the intensity of illumination at the sensor. A further source of sensor current variability results from variations in sensitivity between individual sensors and their inherent spectral sensitivity.

With reference to FIG. 2, video generator 310 is instructed by control logic 301 to generate an exemplary green video block M having an initial non-peak video value and positioned on a substantially black or black level background. Similar video blocks with non-peak video values may be generated in each color channel, which when generated simultaneously and superimposed at the screen produce a white image block on a substantially black background. Thus, an exemplary green block M is generated by video generator 310 and coupled via amplifier 510 to the green CRT. The video generator 310 is controlled by the micro controller 301 to generate the green block M at a horizontal and vertical screen position such that a specific sensor, for example, sensor S1, is illuminated by green light from block M. Illumination of the sensor results in a photo generated current which is processed by amplifier U280, as will be described, to produce pulse Isen, as depicted in FIG. 2.

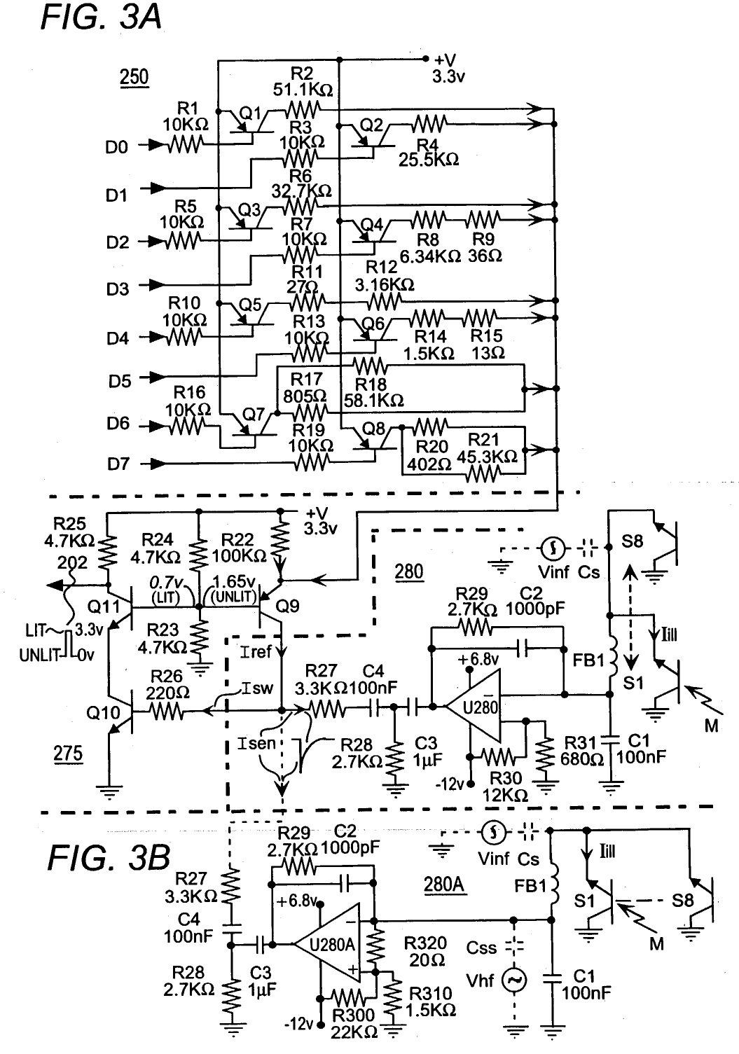

The widely differing photo generated sensor currents described previously are advantageously compensated, calibrated and measured by means of control loop 100 depicted in FIG. 2. A sensor processor is depicted in circuit block 200, and is shown in greater detail in FIG. 3A. In simple terms a reference current Iref is generated by a digitally controlled current source and in the absence of sensor illumination is supplied to sensor detector 275 as current Isw which biases detector 275 such that the output state is low, which is chosen to represent an unlit or unilluminated sensor condition. When a sensor, for example S1-S8 is illuminated, photo generated charge is processed to form a negative going pulse Isen at the output of amplifier 280. The negative pulse Isen diverts the constant current reference Iref, thus reducing switch current Isw and causing sensor detector 275 to turn off. With detector 275 pulsed off the output assumes a high, nominally supply voltage potential, which is chosen to be indicative of a lit or illuminated sensor. The output from sensor detector 275 is a positive going pulse signal 202 which is a coupled to an input of digital convergence IC 300. The rising edge of pulse signal 202 is sampled causing horizontal and vertical rate counters to stop thus providing counts which determine where in the measurement matrix the lit sensor occurred.

The sensor current is advantageously measured by controllably increasing reference current Iref until sensor detector 275 switches to indicate loss of sensor illumination. The value of reference current that caused detector 275 to indicate loss of sensor illumination is representative of the level of illumination incident on the sensor. Thus this current may be processed and stored as a sensor and color specific threshold value. The stored reference current value differs between sensors and from color to color, but detector switching is equalized to occur for illumination values of down to one half of the measured Isen switching value.

Sensor processing block 200 of FIG. 2 is shown in detail in FIG. 3A and includes digitally controlled current source 250, sensor detector 275, and photo sensor amplifier 280. Current source 250 generates a controlled current Iref with a magnitude determined by a digital control word D. Data word D is generated by controller 301 and comprises 8 parallel data signals D0-D7, representing from least to most significance respectively. The individual data bits are coupled via series connected resistors R1, R3, R5, R7, R10, R13, R16 and R19 to the bases of corresponding PNP transistors Q1, Q2, Q3, Q4, Q5, Q6, Q7, and Q8. The emitter of each transistor is connected to a positive supply +V and each collector is coupled via various resistors to the emitter of a PNP current source transistor Q9. Hence the current sourced by transistor Q9 is controlled by emitter resistor R22 and the parallel combination of the digitally selected resistor network. The current switching transistor collector resistors R2, R4, R6, R8 and R9, R11 and R12, R14 and R15, R17 and R18, R20 and R21 are chosen to have values of resistance which increase in a binary sequence. For example, the parallel combination of resistors R20 and R21 approximate to 400 ohms, and resistor combination R17 and R18 approximate to 800 ohms. Thus digital word D0-D7 can select resistance values between 200 ohms, with all transistors turned on, and 100 kilo ohms due to resistor R22, with all transistors turned off. Digital word D0-D7 has voltage values of zero and 3.3 volts, with resistor selection occurring when a data bit has a zero volt value, and no resistor selection when the bit has a 3.3 volt value. Thus resistor R22 and the potential at the base of transistor Q9, determine the magnitude of a reference current Iref, generated at the transistor collector.

The digitally determined current Iref is coupled via resistor R26 to the base of transistor Q10, and causes the transistor to turn on. The emitter of transistor Q10 is grounded and the collector is connected to the emitter of NPN transistor Q11 to form a cascode connected amplifier. The base of transistor Q11 is biased by a voltage divider formed by resistors R24 and R23. Resistor R24 is connected to the positive supply and resistor R23 is connected to ground. The junction of resistors R23 and R24 biases the bases of transistors Q9 and Q11 to about 1.65 volts when the base emitter junction of transistor Q11 is not conducting. The collector of transistor Q11 generates an output signal 202, which indicates the illuminated state of sensor S1, i.e. lit or unlit, for coupling to a digital convergence integrated circuit IC 300, for example type STV2050 or to an input of a micro processor.

The sensor detector of 275 of FIG. 3A operates as follows. Reference current Iref is coupled to the base of transistor Q10 as switch current Isw but is diverted via resistors R27, R28 and capacitors C4, C3 to form sensor current Isen whenever a sensor, for example, S1-S8 is illuminated by marker block M. Switch current Isw causes transistor Q10 to turn on and saturate, forcing the collector to assume a nominally ground potential of Vcesat, approximately 50 millivolts. Hence, the emitter of transistor Q11 is nominally grounded via the saturated collector emitter junction of transistor Q10, and transistor Q11 is turned on causing the collector to assume a potential of nominally 100 millivolts or (Q3 Vcesat+Q4 Vcesat). The collector of transistor Q11 forms output signal 202 where nominally zero volts indicates an unlit sensor condition and the nominal supply voltage represents a lit sensor.

With transistor Q10 saturated, the emitter base potential of transistor Q11 is reduced from nominally 1.65 volts, due to the resistive divider R23 and R24, to a voltage of about 0.7 volts formed by the base emitter junction voltage of transistor Q11 and the saturation voltage of transistor Q10. Since the base of current source transistors Q9 and cascode transistor Q11 are joined, the bias at the base of current source transistor Q9 is also reduced to nominally 0.7 volts. This change in base potential at transistor Q9 results in constant current Iref increasing by about three times.

The operation of photo sensor amplifier block 280 will be described later. However, when a sensor for example S1 is illuminated by a projected marker block, a negative going current pulse Isen is formed as a result of advantageous amplitude and frequency response processing by amplifier block 280. Since the reference current Iref is constant, the lit sensor pulse current Isen is diverted from the base current (Isw) of transistor Q10, causing the transistor to turn off. With transistor Q10 off, transistor Q11 is turned off causing the collector to rise to the supply voltage, generating output signal 202 of nominally 3.3 volts amplitude indicating a lit sensor. As described previously, with transistors Q10 and Q11 turned off, the base bias of current source transistor Q9 reverts to the potential determined by the resistive divider (R23 and R24) with the result that the magnitude of constant current Iref is decreased by approximately 66%. Thus, the reduction in reference current Iref advantageously sustains or latches the lit sensor condition by establishing a lower switching threshold for terminating detection and indicating a sensor off or unlit condition.

The operation of photo sensor amplifier block 280 is as follows. As described previously, photo sensors S1-S8 are located around the periphery of display screen 700 and can be connected in a parallel arrangement to a single amplifier, for example U280, or can be individually coupled to corresponding amplifiers. However, the selection of parallel or individual sensor connection plays little part in the signal to noise ratio impairment of the photo sensor signal.

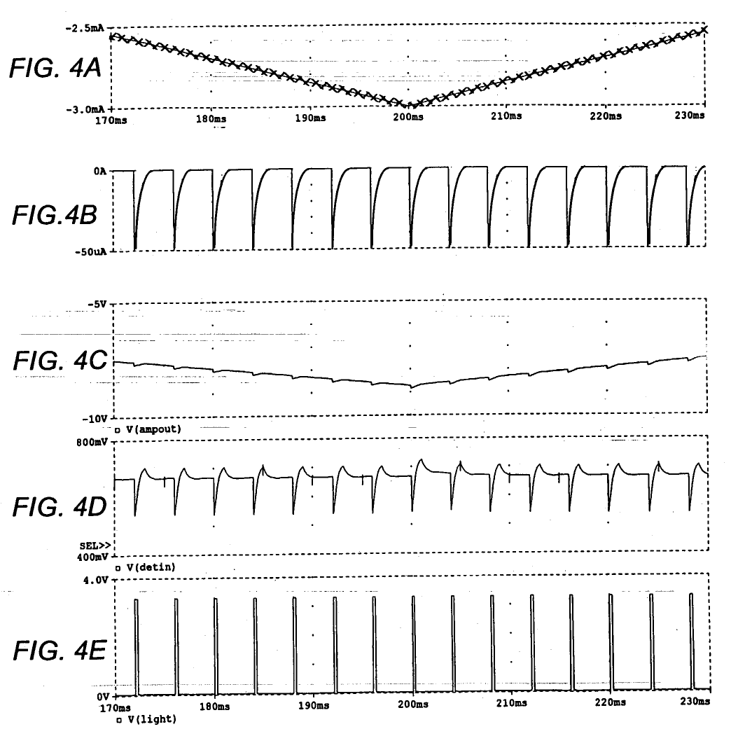

Ambient illumination of the display screen and photo sensors may be the product of sunlight, and incandescent or fluorescent lamps. Typically ambient illumination produces slowly varying, low frequency waveform signal representative of intermittently shaded sunlight and or artificial lighting falling on the projection screen and sensor. With such ambient lighting, the resulting photo sensor signal includes a variable amplitude DC component, plus a low frequency component. The presence of artificial illumination produces power line frequency related broad band noise spectra extending into the megahertz frequency range. Whilst it may appear that the sunlight component can be easily eliminated, it's associated low frequency variations can cause the loss or impairment of wanted sensor signals generated by the projected measurement marker M. FIG. 4A is a simulation of a sensor signal subject to unwanted illumination by sunlight with shadows and artificial illumination occurring during measurement of a projected marker M. The waveform selected to simulate shaded or intermittent sunlight has a triangular wave with an peak to peak amplitude of 3 milleamperes and a frequency approximately 2 Hz. A higher frequency noise component, shown by cross hatching, is superimposed on the triangular wave. The wanted sensor signal, corresponding to the CRT generated and projected marker M, is depicted in FIG. 4B. The period of the simulated marker derived signal is chosen to be 4 mine seconds to facilitate four marker measurements per display field. The simulated marker derived sensor signal has a peak amplitude of 50 micro amperes, a rise time of approximately 50 micro seconds and a decay time of nominally 1 millesecond. Thus it can be appreciated that the unwanted to wanted signal amplitudes are rather adverse, having a ratio of approximately 60:1.

The sensor signal input to amplifier U280 includes both wanted and unwanted signal components plus other extraneous induced signals. The unwanted signal components have amplitudes that largely obscure the intermittent flashing of the projected measurement block M. As described previously, the slowly varying low frequency signal can result from various sources of ambient light obscuration, for example varying cloud cover, shrub or tree motion, or even human shadows. Typically the broad band noise emanates from artificial light sources or sunlight.

Thus having recognized that the ratio of wanted to unwanted signal amplitudes is approximately 60:1 the photo sensor signal is coupled to amplifier block 280 where the unwanted signal components are substantially eliminated by signal processing. Eight photo sensors, S1 to S8, are shown in block 280, connected in parallel with respective emitters coupled via a low pass filter and summed at a common node formed at the input terminal of operational amplifier U280, for example type TL082. A stray or parasitic capacitance Cs is depicted in FIG. 3A, connected in series with an interfering voltage source Vinf. This interfering signal source is shown at the junction of the sensor emitters, however, this capacitance and the coupled interference signals are distributed throughout the sensor interconnections. A lowpass filter is formed by series connected ferrite inductor FB1 and capacitor C1 connected to ground. The ratio of values for stray capacitance Cs and capacitor C1 provide significant attenuation of coupled or induced voltages, Vinf, resulting from, for example, radio frequency interference, scanning frequency signals or high voltage kinescope arc components that may cause spurious operation of amplifier U280 or even component damage.

When any photo sensor is illuminated a photo generated current, for example Iill, flows from ground via the collector emitter junction of the illuminated photo sensor transistor to the lowpass filter. The lowpassed sensor signal current is applied to the inverting input of operational amplifier, U280, and is converted into a low impedance voltage at the output terminal. A feedback resistor R29 is connected from the amplifier output to the inverting input to produce an output voltage in proportion to the photo sensor input current. The non-inverting input of the amplifier is connected to a voltage source, for example −0.6 volts, generated by a potential divider formed by resistors R30 and R31 connected between a minus 12 volt supply and zero volts or ground potential. The gain of amplifier U280 for sensor currents is high being determined by feed back resistor R29 and parallel connected capacitor C2. The amplifier gain forces the voltage at the inverting input to be very nearly equal to the voltage at the non-inverting input, for example minus 0.6 volts. Thus, the voltage at the inverting input is applied to bias the photo sensors, S1 to S8, with a constant voltage across the respective collector emitter junctions. At the output of amplifier U280 a low impedance voltage version of the sensor signal is formed which is DC coupled and increases in negative amplitude with increasing sensor illumination and thus sensor current. A relatively large amplitude negative power supply voltage is supplied to amplifier U280 to allow for amplifier headroom or output signal swing to permit large negative signal voltages resulting from large photo generated currents caused by high levels of ambient light. The ohmic value of feedback resistor, R3, is determined such that marker derived current pulses of, for example, 50 microamperes can be resolved by subsequent detector 275 while ambient light related currents of, for example 3 milleamperes are amplified linearly thereby obviating amplifier overload and attendant loss of feedback loop control and wanted signal components. Feedback resistor, R29 is connected in parallel with a capacitor, C2, to provide frequency selective feedback which limits the amplifier high frequency response of amplifier U280 to a cutoff frequency of about 58 KHz. This high frequency feedback advantageously reduces the bandwidth of the amplifier and thereby minimizes unwanted noise and extraneous signal pickup in the sensor signal. The output from amplifier U280 is depicted in FIG. 4C where the wanted marker signal pulses are visible at small saw teeth.

The output from amplifier U280 is AC coupled via capacitor C3 to a load resistor R28 which is connected to ground. Capacitor C3 and resistor R28 form a first section of a high pass filter. The junction of capacitor C3 and resistor R28 is also connected to capacitor C4 which is connected in series with resistor R27 to form a second high pass filter section. The first filter section removes the DC component of the ambient light signal and, as a consequence of the low cutoff frequency of approximately 60 Hz, significantly reduces the amplitude of slowly varying signal components related to variable shadow illumination of the display screen. However, positive or negative pulses caused, for example by wanted marker flashes, are coupled to the second filter stage. Negative going, photo generated voltage peaks result from marker block M which can be considered to flash as a consequence of the periodically scanning of a small area of phosphor that is bounded at the exit pupil of the lens as viewed by each sensor location. Such measurement marker flashes although occurring at a nominal 60 Hz rate, have a rapid rise time and a fall time that is significantly shorter than the period of the 60 Hz rate. The time constant of the first high pass filter stage is chosen to remove, or significantly reduce the effect of currents which charge and discharge capacitor C3 as a consequence of slowly changing ambient light levels thus preventing overloading of detector 275. In summary, feedback amplifier U280 and the output high pass filter arrangement provide a band pass filter characteristic having a low frequency cutoff of about 60 Hz and high frequency limit of about 60 KHz.

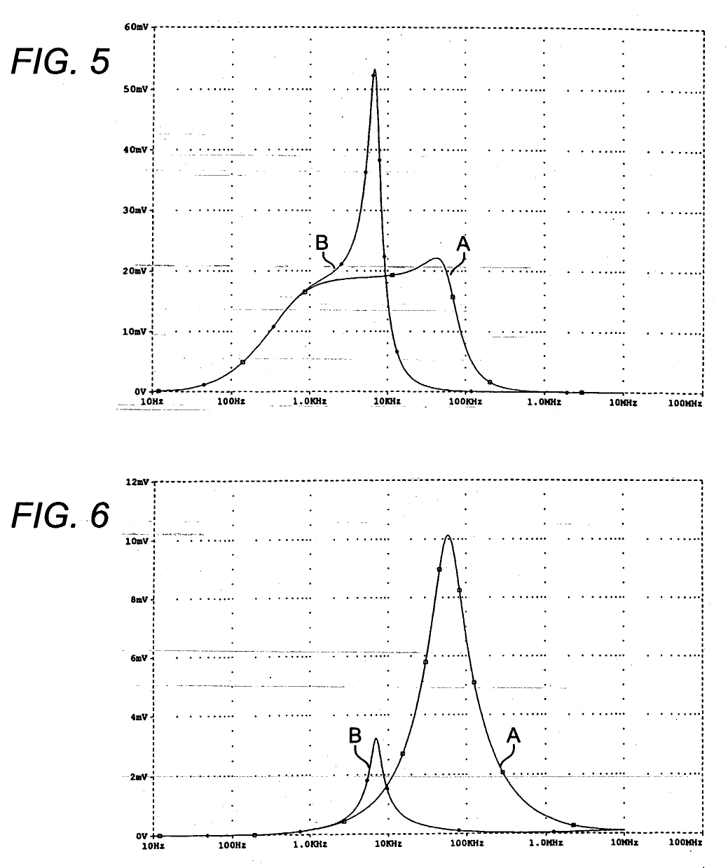

The amplitude frequency response plot shown in FIG. 5, curve A, represents the photo sensor signal response of feedback amplifier U280 measured at the second filter section between capacitor C4 and resistor R27 when a sensor current pulse of 50 microamperes is applied to the inverting input. In FIG. 6, curve A, represents the response of feedback amplifier U280 when subject to an interfering signal of 1 volt amplitude coupled via a 10 picofarad capacitance to the inverting input.

The amplified and bandpass filtered signal from capacitor C3 forms negative going voltage pulses across resistor R28. These voltage pulses are AC coupled via capacitor C4 and converted to current pulses by resistor R27. FIG. 4D depicts these wanted voltage pulses at the junction of capacitor C4 resistor R27. Capacitor C4 and resistor R7, are connected in series to form the second section of the high pass filter stage. Capacitor C4 blocks DC current Iref and charges to the base potential of detector transistor Q10. Both positive and negative impulses present in the filtered sensor signal are coupled to the base of transistor Q10. The positive impulses are clamped, via resistor R26, by the base emitter junction of transistor Q10, while negative going current pulses, derived from marker illumination of the sensor divert current from constant current Iref causing transistor Q10 to turn off. As has been previously described, when transistor Q10 turns off a logical 1 value results at the collector of transistor Q11 and forms output signal 202, depicted in FIG. 4E, having a voltage value of 3.3 volts indicating marker illumination of the sensor. Thus the inventive amplifier with bandpass frequency characteristic substantially removes unwanted ambient light components from the photo sensor signal thereby enabling automated setup during screen illumination by ambient light.

In the circuit of FIG. 3B, a high frequency interference signal Vhf is shown coupled by an exemplary crosstalk mechanism, Css, into sensor signal amplifier U280A. When amplified this crosstalk component can degrade the sensor signal to noise ratio and cause spurious convergence marker detection in subsequent circuitry. In an inventive arrangement, this crosstalk signal is substantially reduced by coupling to the differential inputs of amplifier U280A to utilize the common mode rejection of the operational amplifier. In FIG. 3B, the same component designations are used as in FIG. 3A, with new components and values designated by three digit numbers. The common mode input connection is provided by resistor R320, for example 20 ohms, which is connected between the differential inputs of amplifier U280A. The bias voltage divider resistors R300 and R310 are increased by a factor of 2 relative to the values shown in FIG. 3A. Operation of the inventive arrangement is as follows.

An interfering, high frequency crosstalk signal, Vhf, is shown in FIG. 3B, coupled via an exemplary stray capacitance Css, for example between adjacent terminals of other amplifier sections (not shown) of the IC package, for example type TLO82, containing amplifier U280A. Alternatively crosstalk can occur between adjacent circuit board conductors or circuitry coupled to the inverting input of photo sensor amplifier U280A. Resistor R320 is advantageously arranged to couple a very large fraction of the interfering signals to the non-inverting input of amplifier U280A to form a common mode input signal. The application of substantially the same signal to both inputs produces an output signal where the crosstalk component Vhf is greatly reduced in amplitude. However, although the feedback around amplifier U280A attempts to maintain the two inputs at the same potential, resistor R320 forms part of an attenuator at the non-inverting input which ensures that the inputs are different. This difference results in the negative feed back signal at the inverting input, being fractionally coupled to the non-inverting input to form positive feedback which produces a signal peaking effect.

The signal gain of amplifier U280 for crosstalk signal Vhf is divided by the capacitive divider formed by capacitors Css and C1, and with the exemplary values shown in FIG. 3B, is between 1 and 2 for interfering signals in the 30 KHz range. This gain value is significantly reduced from the open loop gain level of amplification provided for the capacitive divider formed by capacitors Cs and C1 which divide interfering signal Vinf in the circuit arrangement of FIG. 3A. The value of coupling resistor R320 is selected based on the input voltage offset specification for amplifier U280A. The offset voltage of amplifier 280A will be amplified by the ratio of the attenuator formed at the non-inverting input by the parallel resistance of resistors R300 and R310, divided by common mode coupling resistor R320, [(R300//R310)/R320]. For example, with the resistor values depicted in FIG. 3B the ratio is approximately 70:1, thus with an exemplary input offset voltage of +/−5 mine volts, the operational amplifier will amplify the exemplary offset signal by 70 times, producing about +/−350 mine volts variation at the inverting input of amplifier U280A. It is important to maintain a bias voltage of between 0.5 and 3 volts across photo sensors S1-S8. This bias voltage is formed at the inverting input as a result of operational amplifier feedback action which attempts to maintain the two inputs at the same potential. Hence the voltage at the non-inverting input is tracked by the inverting input. The amplifier output voltage swing due to the offset will be larger than the swing at the non-inverting input as a result of the attenuation described previously. However, this amplified offset voltage is not important because low pass filter capacitor C3, blocks the DC component at the amplifier output. A nominal photo sensor bias of minus 0.8 volts is formed by potential divider resistors R300 and R310. This bias value is chosen to provide sufficient head room to keep the bias for the optical sensor transistors above 500 mille volts.

Negative feedback is provided by the parallel combination of resistor R29 and capacitor C2, which are coupled from the output to the inverting input of amplifier U280A. This feedback forces the voltage across common mode resistor R320 to be substantially zero, and thus the voltage amplitude of interfering signal Vinf is similarly reduced. Because the feedback produces substantially zero voltage across common mode resistor R320, the sensor current 111t is substantially blocked from flowing through resistor R320 and effectively flows through feed back resistor R29 to produce a sensor signal voltage at the output of amplifier U280A.

An amplitude frequency response plot is shown in FIG. 5 where curve B, represents the photo sensor signal response of feedback amplifier U280A measured at the second filter section between capacitor C4 and resistor R27 with an input sensor current pulse of 50 microamperes. FIG. 6, curve B, represents the response of feedback amplifier U280A when subject to an interfering signal of 1 volt amplitude coupled via a 10 picofarad capacitance to the inverting input.

Examination of the respective curves marked A in FIGS. 5 and 6 reveals that the processing arrangement of circuit 280 provides a sensor signal to interference ratio of approximately 2:1 or 6 dB. Thus, although circuit 280 of FIG. 3A provides excellent suppression of sensor response to ambient lighting, and sensor harness pickup, the ability to provide reliable projected marker detection is compromised by a minimal sensor signal to interference ratio, as illustrated in FIG. 6 curve A. The inventive processing arrangement of circuit 280A utilizes a common mode input for the rejection of interfering signal pickup and in addition coupling resistor R320 advantageously provides feedback which peaks the amplitude frequency response as depicted in plots of wanted and unwanted signals shown in curves B of FIGS. 5 and 6. Comparison of the B curves shows that the high frequency response of the bandpass processing arrangement has been significantly reduced from about 60 KHz to about 8 KHz, which locates scan related interfering signals beyond the bandpass of the processing arrangement of circuit 280A. Resistor R320, in addition to enabling common mode input coupling, also provides positive feedback from the output via resistor R29 to the non-inverting input. This positive feedback produces a resonant, or peaking effect within the bandpass frequency range, occurring at about 7 KHz, which increases the wanted signal by approximately 2.5 times relative to that of circuit 280. FIG. 5 curve B illustrates the advantageous conversion of a 50 microampere sensor input signal into an output signal of about 53 millivolts amplitude. With respect to the interfering signal the resulting output voltage amplitude is reduced to about one third, or 3 millivolts in comparison with the performance of circuit 280. The reduction in processor bandwidth and the introduction of bandpass peaking advantageously enhances the wanted to unwanted signal ratio. Comparison of the respective B curves in FIGS. 5 and 6 shows that circuit 280A provides a sensor signal to interference ratio of approximately 16:1 or 24 dB.

The inventive combination of current to voltage conversion for the sensor current signal in combination with the common mode rejection of interfering voltage signals and the resultant bandpass response peaking ensures an optimized sensor signal to interference ratio is coupled to detector 275. The sensor signal coupled for detection is substantially unchanged from that described for the arrangement of FIG. 3A, but is largely free of high frequency crosstalk interference whilst maintaining excellent rejection of ambient illumination.

What is claimed is:

1. A projection display device including a screen image measuring arrangement is subject to unwanted illumination, said arrangement comprising:
a photo sensor located adjacent an edge of said screen for generating an output signal having a first component responsive to illumination by a projected image and a second component responsive to illumination by said unwanted illumination; and,
a filter coupled to said photo sensor for filtering said output signal to pass said first component of said output signal and to attenuate an amplitude of said second component of said output signal.

2. The projection display apparatus of claim 1, wherein a detector receiving said filtered output signal is responsive only to said first component of said output signal.

3. The projection display apparatus of claim 1, wherein a detector receiving said filtered output signal is non-responsive to said attenuated second component of said output signal.

4. The projection display apparatus of claim 1, wherein said filter has a bandpass characteristic and includes an operational amplifier.

5. The projection display apparatus of claim 1, wherein said filter includes an active low pass filter and a passive high pass filter.

6. An automatic convergence arrangement for a projection display apparatus comprising:
a digital convergence circuit generating a convergence image for projection and determining convergence error correction responsive to measurement of said projected convergence image;
a photo sensor located adjacent a display surface for said projected convergence image for generating a sensor signal responsive to illumination by said projected convergence image and ambient light;
a filter for said sensor signal having a characteristic which enhances frequency components of said sensor signal being indicative of said projected convergence image and attenuating frequency components of said sensor signal being indicative said ambient light, wherein said sensor signal processed by said filter being coupled to said digital convergence circuit for measurement.

7. The automatic convergence arrangement of claim 6, wherein said filter has a band pass frequency characteristic.

8. The automatic convergence arrangement of claim 7, wherein said band pass filter frequency characteristic prevents transmission of a DC signal.

9. The automatic convergence arrangement of claim 6, wherein said rate of illumination by said ambient light occurs at a frequency below a rate of 60 Hz.

10. The automatic convergence arrangement of claim 6, wherein said rate of illumination by said projected convergence image occurs at a plurality of frequencies above a rate of 60 Hz.

11. The automatic convergence arrangement of claim 6, wherein said filter includes an operational amplifier with a band pass frequency characteristic.

12. The automatic convergence arrangement of claim 7, wherein said filter characteristic is selected to pass frequencies within said plurality of frequencies generated by said projected convergence image.

13. An automatic control arrangement for a video projection image display apparatus projecting an image on a surface in the presence of ambient illumination having a greater intensity than said projected image, comprising:
a photo sensor positioned for illumination by said projected image and said ambient illumination, said photo sensor generating a signal having components representative of said intensities of said projected image and said ambient illumination;
a filter for said signal having said components representative of said respective intensities and generating a filtered output signal wherein said components representative of said respective intensities are changed such that said component representative of said projected image has an amplitude greater than said component representative of said ambient illumination; and, a convergence circuit providing convergence control of said projected image in accordance with a measurement of said component representative of said projected image present in said filter output signal.

14 The automatic control arrangement of claim 13, wherein said filter characteristic amplifies said component representative of said projected image.

15. The automatic control arrangement of claim 13, wherein said filter characteristic attenuates said component representative of said ambient illumination.
